(19) United States
(12) Patent Application Publication
(10) Pub. No.: US 2005/0212480 A1
(43) Pub. Date: Sep. 29, 2005

(54) Charger adapter

(75) Inventor: Yu-Kun Kao, Hsin-Tien City (TW)

Correspondence Address: Troxell Law Office PLLC, 5205 Leesburg Pike, Suite 1404, Falls Church, VA, 22041, US

(73) Assignee: Leader Electronics Inc.

(21) Appl. No.: 10/809,488

(22) Filed: Mar. 26, 2004

(51) Int. Cl. H02J 7/02

(52) U.S. Cl. 320/114

(57) ABSTRACT

A charger adapter is composed of an adapter and a charger detachably and electrically mounted on the adapter. The adapter has a plug formed at a bottom surface thereof. A tongue is formed at an upper surface of the adapter. Two first elongated holes are defined through the tongue. Two teeth are respectively and elastically protruded from the first elongated holes and electrically connected with the connecting member. The charger has a notch defined at a bottom surface thereof for receiving the tongue. Two second elongated holes are defined through the notch. Two contacts are respectively provided in the second elongated holes and corresponding to the teeth. A chamber is defined at an upper surface of the charger.

### BACKGROUND OF THE INVENTION

1. Field of the Invention

The present invention relates to a charger adapter, and more particularly a charger adapter which can be used with an indoor receptacle for electric supply or a vehicle cigarette lighter.

2. Description of Related Art

Chargeable batteries for mobile phones are generally charged by charger adapters specially designed for the batteries. The conventional charger adapter is composed of a charger and an adapter detachably mounted together. In use, the battery is positioned in the charger, and the adapter is electrically connected with an indoor main socket for electrical supply.

However, in an outdoor situation, such as a vehicle, the charger adapter can not be used, and the mobile phone must be directly connected with a vehicle cigarette lighter to charge batteries in the mobile phone.

Furthermore, the conventional charger adapter is generally applied for the plate-like battery and can not charge a cylindrical battery.

Therefore, the invention provides a charger adapter to mitigate or obviate the aforementioned problems.

### SUMMARY OF THE INVENTION

The main objective of the present invention is to provide a charger adapter which can be conveniently used with an indoor mains socket for electrical supply or a vehicle cigarette lighter socket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a charger adapter in accordance with the present invention;

FIG. 2 is an exploded perspective view of the charger adapter in FIG. 1;

FIG. 3 is a bottom perspective view of the charger in FIG. 1;

FIG. 4 is an exploded perspective view of an adapter in FIG. 1 assembled with another embodiment of a charger in accordance with the invention;

FIG. 5 is a perspective view of the charger in FIG. 1 assembled with a further embodiment of an adapter in accordance with the invention;

FIG. 6 is a perspective view of the adapter in FIG. 5; and

FIG. 7 is a perspective view of the adapter in FIG. 5 assembled with the charger in FIG. 4.

### DETAILED DESCRIPTION OF THE PREFERRED EMBODIMENT

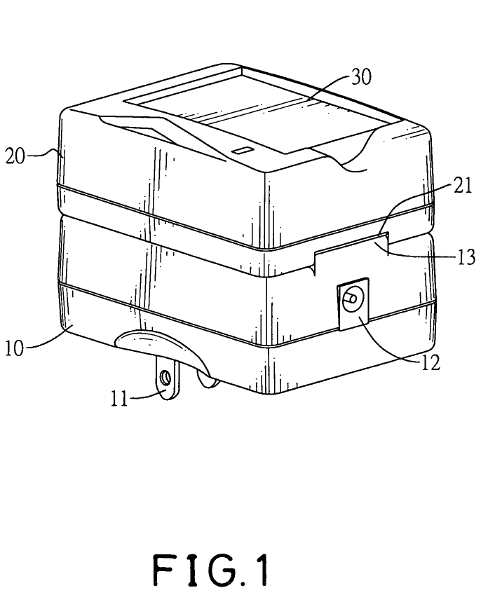

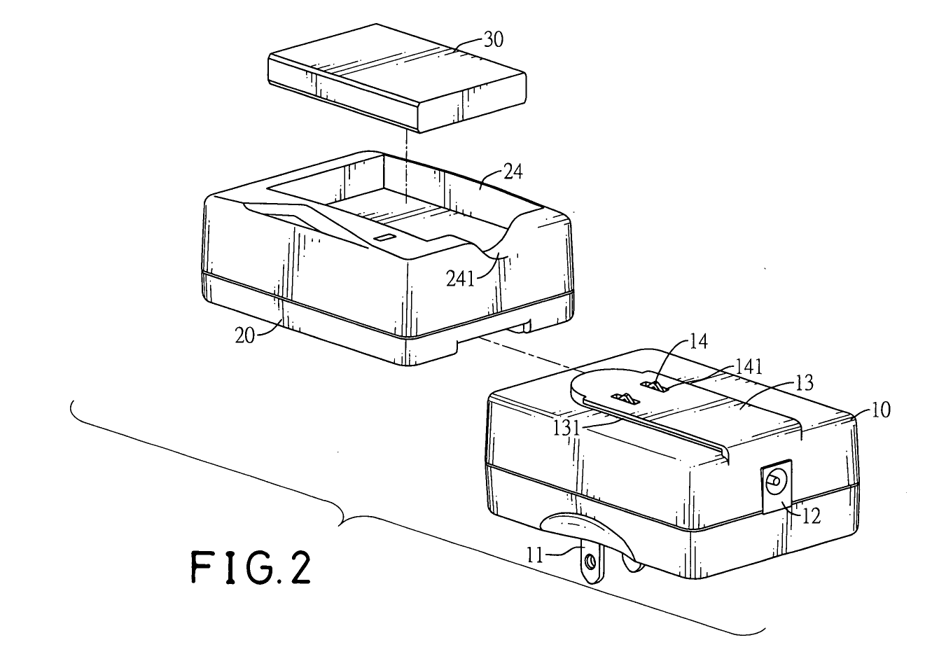

With reference to FIGS. 1-2, a charger adapter in accordance with the present invention is composed of an adapter (10), and a charger (20) detachably mounted on the adapter (10).

The adapter (10) has a foldable plug (11) provided at a bottom surface thereof and matching an indoor receptacle for mains electrical supply. The plug (11) can be made with various sizes and shapes according to specifications of various countries. The plug (11) has a structure similar to the prior arts, which will not be described in detail. A tongue (13) is formed at an upper surface of the adapter (10). Two channels (131) are respectively defined at two sides of the tongue (13). Two first elongated holes (141) are defined through the tongue (13), and two teeth (14) respectively and elastically protruded from the first elongated holes (141). A DC terminal (12) is formed at a side surface between the bottom and upper surfaces of the adapter (10). An electric appliance (not shown), such as a digital camera or mobile phone, can be directly connected with the adapter (10) by a special wire for charging batteries in the electric appliance.

The adapter (10) has a circuit board (not shown) provided therein and respectively electrically connected with the plug (11), DC terminal (12) and teeth (141). Thus, AC current is transformed into DC current output from the DC receptacle (12) and teeth (14).

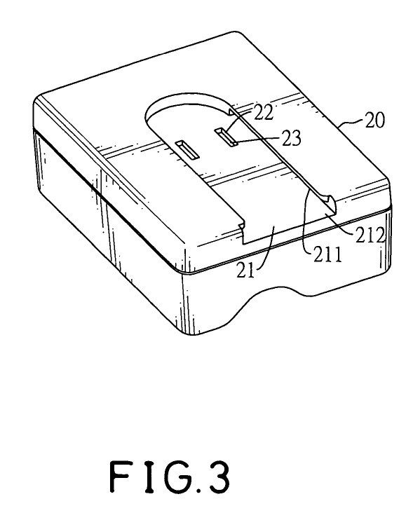

With reference to FIG. 3, the charger (20) has a notch (21) defined at a bottom surface thereof for receiving the tongue (13) to position the charge (20) on the adapter (10). Two bars (211) are respectively formed at two opposed sides of the notch (21) and received in the channels (131) when the tongue (13) is inserted in the notch (21). (Alternatively, the tongue (13) is made with a V-like cross section, and the notch (21) is defined with a V-like cross section matching the tongue (13)). An entrance (212) with a width larger than a distance between the bars (211) is defined at an open end of the notch (21) to facilitate the tongue (13) inserting into the notch (21). Two second elongated holes (22) are defined in the notch (21) and respectively correspond to the first elongated holes (141) of the tongue (13). Two contacts (23) are respectively provided in the second elongate holes (22). When the tongue (13) is inserted in the notch (21), the teeth (14) are respectively positioned in the second elongated holes (22) and electrically connected with the contacts (23). A chamber (24) is defined at an upper surface of the charger (20) for receiving a plate-type battery (30) used for mobile phones. An opening (241) is defined at a side of the chamber (24) to facilitate taking out the plate-type battery (30).

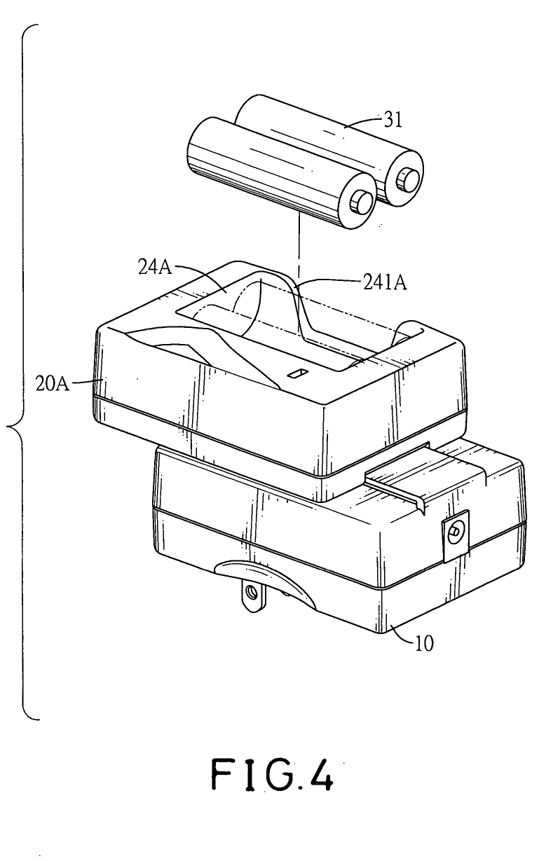

With reference to FIG. 4, in another embodiment, a second charger (20A) has a second chamber (24A) for receiving cylindrical batteries (31). A second opening (241A) is defined at a side of the chamber (24) to facilitate taking out the cylindrical batteries (31).

In use, the charger (20) (or the second charger (20A) is mounted on the adapter (10) by inserting the tongue (13) into the notch (21) through the entrance (212). The bars (211) are respectively engaged in the channels (131), and the teeth (14) are respectively positioned in the second elongated holes (22) to electrically connect the adapter (10) with the charger (20). After charging, by pulling backwards the tongue (13) out from the notch (21), the adapter (10) can be easily detached from the charger (20). Thus, it is very convenient for a user to assemble/disassemble the charger (20) with/from the adapter (10).

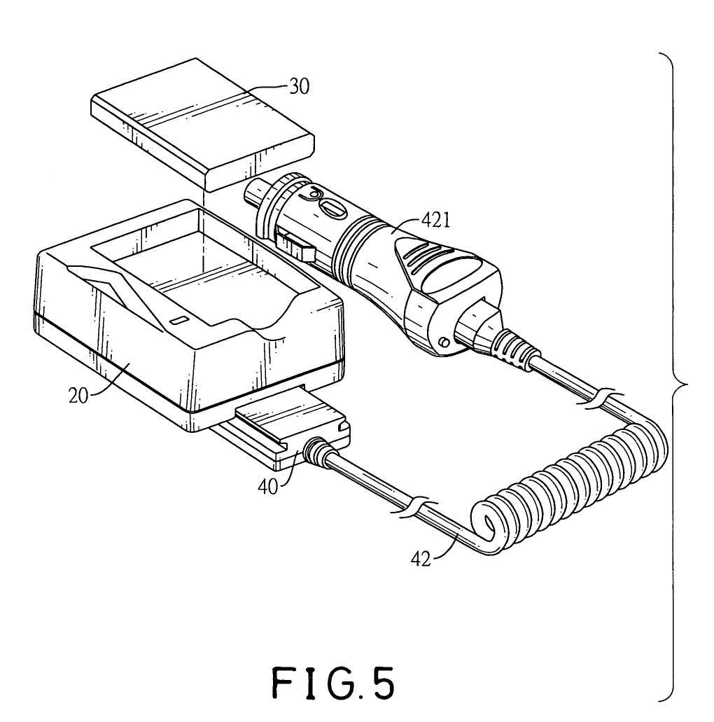

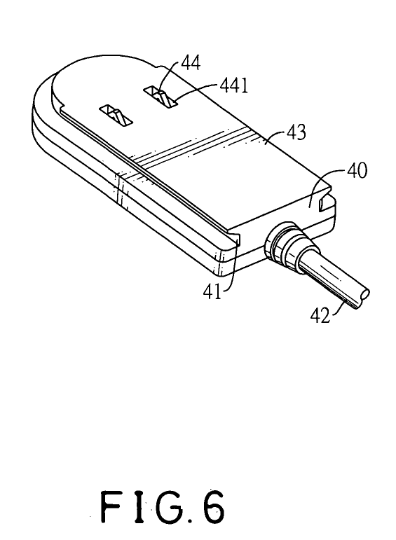

With reference to FIGS. 5-7, in a further embodiment, the charge adapter has a second adapter (40) with a connector (421) matching a cigarette lighter receptacle (not shown) in an automobile and connected by a wire (42) with the second adapter (40). The adapter (40) has a second tongue (43) formed at an upper surface thereof, and two second channels (41) are respectively defined at two sides of the second tongue (43). Two third elongated holes (441) are defined through the second tongue (43), and two second teeth (44) are respectively and elastically protruded from the third elongated holes (441).

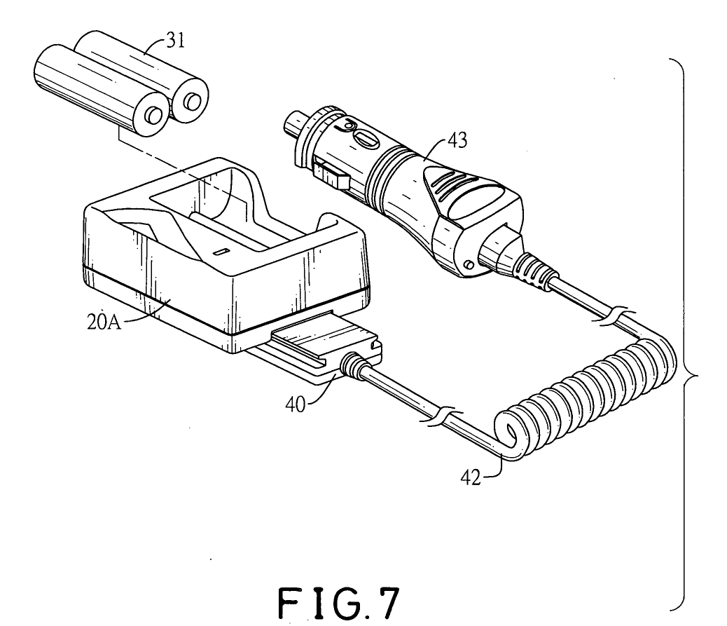

As illustrated in FIGS. 5 and 7, the charger (20) (or the second charger (20A)) can be electrically connected with the second adapter (40) by inserting the second plug (43) into the notch (21). Then, the connector (421) is inserted in the cigarette lighter receptacle for charging the plate-like battery (30) (or the cylindrical batteries (31)).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A charger adapter comprising:
an adapter having a connecting member for being electrically connected with a power supply, a tongue formed at an upper surface of the adapter, two first elongated holes defined through the tongue, and two teeth respectively and elastically protruded from the first elongated holes and electrically connected with the connecting member; and
a charger detachably and electrically mounted on the adapter, the charger having a notch defined at a bottom surface of the charger for receiving the tongue to attach the adapter to the charger, two second elongated holes defined through the notch, two contacts respectively provided in the second elongated holes and corresponding to the teeth, and a chamber defined at an upper surface of the charger.

2. The charger adapter as claimed in claim 1, wherein the adapter has two channels respectively defined at two sides of the tongue, and the charger has two bars respectively defined at two sides of the notch and received in the channels when the tongue is inserted in the notch.

3. The charger adapter as claimed in claim 2, wherein the charger has an entrance defined at an open end of the notch and with a width larger than a distance between the bars.

4. The charger adapter as claimed in claim 1, wherein the charger has an opening defined at a side of the chamber.

5. The charger adapter as claimed in claim 1, wherein the adapter has a DC terminal formed at a side surface thereof.

6. The charger adapter as claimed in claim 5, wherein the connecting member is a plug formed at a bottom surface and matching an indoor electrical outlet.

7. The charger adapter as claimed in claim 1, wherein the connecting member is a connector connected with the adapter by a wire and matching a cigarette lighter receptacle in an automobile.
